(19) United States
(12) Patent Application Publication
(10) Pub. No.: US 2007/0276696 A1
(43) Pub. Date: Nov. 29, 2007

(54) MULTI-AGENT DISTRIBUTED ENVIRONMENT FOR A HIERARCHICAL MEDICAL ENVIRONMENT

(75) Inventors: Daniel Gauvin, Greenfield Park (CA); Roger Gauthier, Brossard (CA); Herve Marchal, Greenfield Park (CA); Jean-Francois Rizand, Montreal (CA)

Correspondence Address: BERESKIN AND PARR, 40 KING STREET WEST, BOX 401, TORONTO, ON, M5H 3Y2, CA

(73) Assignee: TECHNOLOGIES NEW IT INC., Ile des Soeurs (CA)

(21) Appl. No.: 11/456,489

(22) Filed: Jul. 10, 2006

Related U.S. Application Data
(62) Division of application No. 10/109,006, filed on Mar. 29, 2002.

(51) Int. Cl. G06Q 50/00

(52) U.S. Cl. 705/2

(57) ABSTRACT

The invention presents a system and a method that allows clients to communicate with their service providers. In the preferred embodiment of the invention, the clients are patients, the service providers are health care professionals (HCP), and the system is used for intelligent remote health care monitoring. Components of the system are deployed over three different networking zones: a public network, a demilitarized zone (DMZ), and a private network.

### FIELD OF THE INVENTION

This invention relates to the field of distributed environments. More precisely, this invention relates to distributed environments that allow the monitoring of the sharing of data in a medical environment using computer agents.

### BACKGROUND OF THE INVENTION

Healthcare must now be provided to a large growing and aging population.

Being faced with the facing of an aging population, insurance companies and governments are experiencing a reduction of their financial resources. Such reduction may impact on the quality of healthcare, which is not desirable.

Patients may be long-term patients as well as occasional patients who need short-term care. It will be appreciated that patients suffering from long-term illness are very costly to the insurance companies and governments. In some cases, the long-term patients have to meet medical professionals who will follow an action plan, which may be very simple such as monitoring physiological data such as blood glucose.

A patient visit for a routine measure is very costly.

The meeting of medical professionals is not cost-effective in the case of an automatic action that could have been done by the patient. On the other hand such automatic action may be mandatory and critical for the following of the patient.

Brown described in U.S. Pat. No. 6,168,563 a remote health monitoring and maintenance system. The apparatus developed by Brown enables a simple remote patient monitoring.

However, it may be difficult to use the system in the case of a large number of patients interacting simultaneously with various types of medical professionals.

Furthermore, it may be desirable to format an action plan to the specific requirements of a medical institution.

There is therefore a need for a method and apparatus for providing a flexible remote monitoring of a patient.

### SUMMARY OF THE INVENTION

It is an object of the invention to provide a method and apparatus for sharing data between a client and a plurality of professionals;

Yet, another object of the invention is to generate protocols for a client;

According to one aspect of the invention, there is provided a method for sharing data between a client and a plurality of professionals according to an action plan, the method comprising the steps of generating an action plan for a client, the generating being performed by at least one of a plurality of professionals; performing a subscription request for information related to the client action plan, the subscription request being performed by one of the plurality of professionals; authenticating said subscription request; setting access rights for each of the plurality of professionals with which provided data is shared; providing periodically data from the client and sharing the provided data according to said access rights.

According to another aspect of the invention, there is provided a method for generating an clinical protocol for a patient suffering from an illness, the clinical protocol comprising a list of tasks to be performed by a patient, the method comprising the steps of selecting a generic clinical protocol in accordance with the illness of the patient, the selecting comprising the providing of an identifier identifying the illness, the selecting being generated by a medical professional; providing the generic clinical protocol to the medical professional; modifying the provided generic clinical protocol to adapt it to the patient, the modification being performed by the medical professional to create an clinical protocol, the modifying comprising the providing of at least one of the list of tasks to be performed in accordance with the illness of the patient; transmitting the clinical protocol to the patient and executing the transmitted protocol.

### BRIEF DESCRIPTION OF THE DRAWINGS

The foregoing aspects and the advantages of this invention will be become easily understood using the following detailed description with the accompanying drawings, in which:

FIG. 1 is a diagram which shows the three types of zones involved in the system;

FIG. 2 is a diagram which shows the components of the public network;

FIG. 3 is a diagram which shows the components of the Private Network Zone;

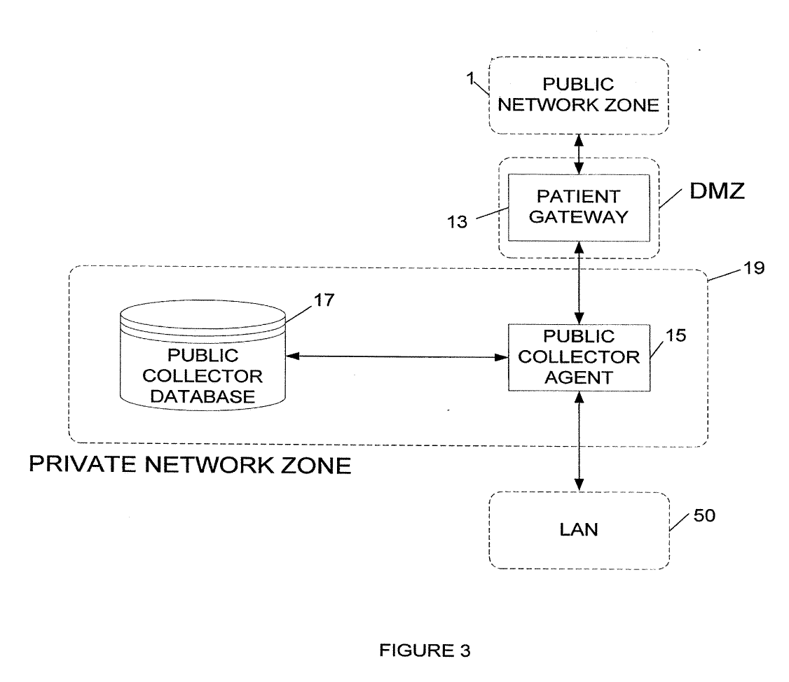

FIG. 4 is a diagram that shows the components of the Local Area Network (LAN).

### DETAILED DESCRIPTION OF THE PREFERRED EMBODIMENT

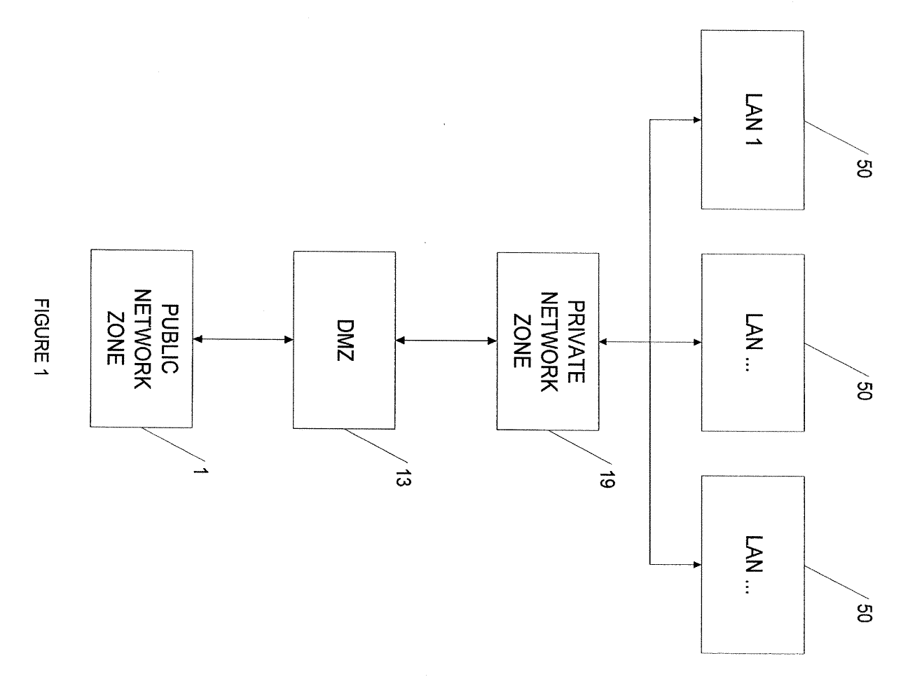

Now referring to FIG. 1, there are shown the 3 different types of zones involved in this invention.

A public network zone 1 is used. As explained below, the public network zone 1 will be used by a client. In the preferred embodiment of the invention, the Internet is used in the public network zone. A DMZ 13 is connected to the public network zone 1 and to a private network zone 19. The DMZ 13 may be seen as a buffer. A local area network (LAN) may be used in the private network zone 19. The local area network may be a token ring network or an Ethernet type network.

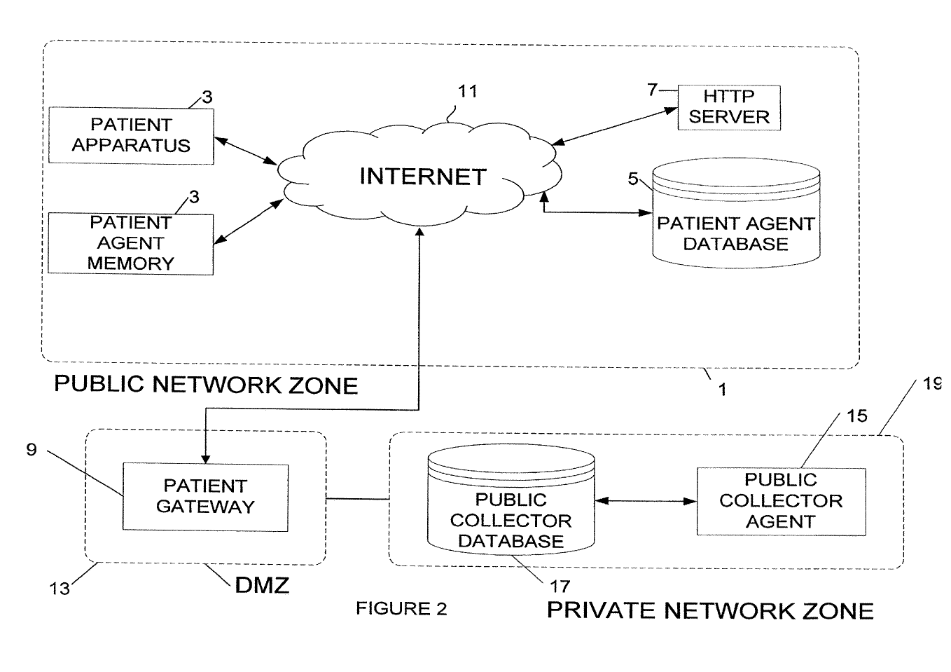

Now referring to FIG. 2, there is shown the system's deployment over the public network zone 1. The main entities having access to the public network 11 are a patient apparatus 3, a patient agent memory 5, an HTTP server 7, and a patient gateway 9.

The patient apparatus 3 is operable by a patient and can be any apparatus having a microprocessor and a communication module, such as a personal computer, a PDA, or a pocket PC. In a preferred embodiment, the patient apparatus 3, provided by the health care facility, is user-friendlier than a personal computer and can be very convenient for patients with limited computer literacy, since it has an integrated bootstrap, and allows patients to enter data using a touch screen. In one embodiment, the bootstrap is integrated in a memory of the patient apparatus 3. In another embodiment, the bootstrap is provided in a CD-Rom. The patient apparatus 3 also has a plug-in interface, allowing patients to plug medical devices, and transmit medical measurements to their Health Care Professional (HCP), through the system.

In order for a patient to receive his protocols, the patient activates the bootstrap, which causes the patient apparatus 3 to download a personal patient agent from a patient agent database 5. In the preferred embodiment, the download is performed by a first connection through the HTTP server 7. The downloaded patient agent then prompts the patient for his ID code, and sends it to a public collector agent 15 via the patient gateway 13. The public collector agent 15 is located in the private network zone 19. Using the patient's ID code, the public collector agent 15 retrieves the patient's recent monitoring data, as well as his current and future protocols from various institutional collector databases as explained below.

The information related to a patient is then sent to the patient apparatus 3. Upon receipt of the data, the patient agent begins the protocol merging process.

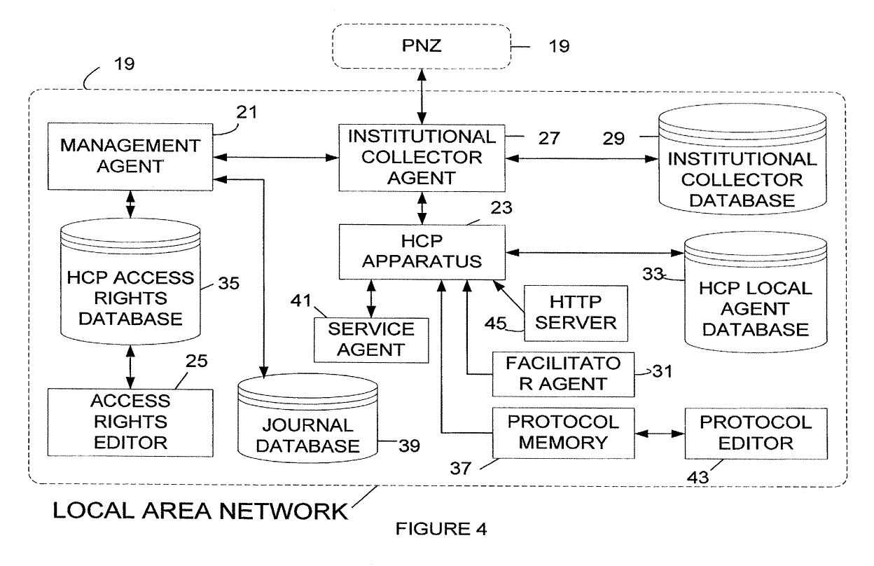

Now referring to FIG. 4, there is shown the LAN 50.

The LAN 50 comprises a large variety of agents interacting together as explained below.

The transmission of medical data requires a high level of security, and many precautions have to be taken to enforce data confidentiality. The administration of the health care facility provides to each Health Care Professional (HCP), a username and a password to restrict access to its HCP apparatus 23. In addition, the administration of the health care facility establishes an HCP access rights database 35 that specifies the type of monitoring data that each HCP working in the institution is entitled to request as well as the type of operations that each HCP is entitled to perform, such as creating a patient profile, modifying a protocol, printing monitoring data, etc.

In the preferred embodiment of the invention, a private key is generated for each agent on the network; a certificate generated from the private key is exported to a certificate database 46 for data authentication and encryption. The certificate database 46 is protected by a password and maintained by a system administrator. All communications between agents use SSL and require each an agent authentication. As for data storage, there is no centralized database. For security purposes, each agent locally stores an encrypted version of the data it handles using its private key. Therefore, once an agent stores data, it is the only one capable of retrieving the data, since each agent has its own encryption key.

The administration of the health care institution is provided with a protocol editor 43 in order to edit generic protocols stored in the protocol memory 37 according to their practices. The access rights editor 25 may be used to edit the HCP access rights stored in the HCP access rights database 35.

As explained previously, an HCP determines that his patient needs remote monitoring, he gives him a bootstrap on a CD, or any form of mobile memory, that will enable him to download his personal patient agent on his personal computer. In case the patient does not have a personal computer, he is given a patient apparatus.

For the purposes of the description, it will be assumed that the HCP who established the patient's diagnosis is the patient's doctor.

After establishing the diagnosis, the doctor activates an HCP apparatus 23, which will prompt him for his username and password. The doctor may own his own HCP apparatus 23 or share the HCP apparatus 23 with other HCP.

The username and the password are sent to a management agent 21, to authenticate the doctor according to the HCP access rights database 35. Once authenticated, the doctor may activate a software that will allow him to delegate the patient monitoring duty to another HCP. In order to perform the patient monitoring delegation, the software prompts the doctor for a description of the patient's medical status, details on the prescribed treatment plan, the ID of the HCP designated for the task, and the date at which the HCP should start the monitoring process. Once the required data is entered, the task is saved in an HCP local agent database 39. For the purposes of the description, it will be assumed that the designated HCP is a nurse.

In order to start the monitoring process, the designated nurse activates an HCP apparatus 23. The HCP agent, running on HCP apparatus 23, will first prompt the nurse for a username and password, and sends them to the management agent 21 for authentication using the HCP access rights database 35. Once the nurse is authenticated, the HCP agent downloads her access rights from HCP access rights database 35. The HCP agent then downloads all the protocols and monitoring data relating to her from the HCP agent local database 33, and creates a local journal on the hard disk of the HCP apparatus 23, to keep track of its own operations.

In addition, the HCP agent requests from the management agent 21, the creation of another journal, stored in the journal database 39, to keep track of the nurse's operations.

Afterwards, the HCP agent downloads two additional files from the HCP local agent database 33: a duty file and a list of scheduled tasks.

The duty file specifies the duties associated with an HCP profile, and refers to files describing the characteristics of the service agents 41 required for performing these duties. In a preferred embodiment, the files describing the HCP duties are XML documents. The duty file corresponding to the nurse's HCP profile refers to creating patient agents and providing remote patient monitoring, and consequently, the HCP agent downloads files called “creation of patient agent” and “remote patient monitoring”, from the HCP local agent database 33.

As for the list of scheduled tasks, it lists all the tasks delegated to an HCP by his superior. In this case, the first scheduled task for the nurse is to create a patient agent for the patient. Once the appropriate files and list of scheduled tasks have been downloaded, the HCP agent reads the first scheduled task on the list of scheduled tasks, and uses the “creation of patient agent” file to determine the characteristics of the required service agent 41. A facilitator agent 31 locates the service agent 41 matching the determined characteristics, and the HCP agent negotiates with the located service agent 41 to establish the conditions under which they can execute the scheduled tasks.

The negotiations between the HCP agent and the service agent 41 are initiated by a “call for proposal” sent by the HCP agent and containing the “create patient agent” task. The service agent 41 responds with a “propose” message defining the conditions under which it can perform the task. As an example, one of these conditions is the download and execution of specific code, stored in an HTTP server 45. Another condition is to provide the HCP with means to input data. If the HCP agent can satisfy all the required conditions, it sends an “accept proposal” message. Otherwise, the HCP agent will send a “reject proposal” message, which cancels the execution of the scheduled task. After receiving an “accept proposal” message, the service agent 41 performs the scheduled task of creating the patient agent. The nurse will be required to enter data defining the patient to be monitored, such as his name, his medical file number, the names of the doctors handling his case, his user code, and so forth.

The HCP agent uses the entered data to generate a “PatientRecord” message, which will be stored in an HCP local agent database 33, and sent to an institutional collector agent 27, under the name “inform(PatientRecord)”. The nurse then selects a generic protocol to be downloaded by the HCP agent from the protocol database 37, and customizes the selected protocol according to the patient's profile and the doctor's diagnosis. In the preferred embodiment, the generic protocols are XML documents. Examples of protocol customizations performed by an HCP include setting drug dosages, prescribing additional activities, setting the language in which the protocol will be displayed to the patient, scheduling the execution of specific steps in response to specific monitoring data, adding messages, indicating the starting date of the monitoring process, its duration, and so forth. The customized protocol, “HealthCareEpisod” is then transformed into a Java object, “inform(HCE)”, and both “HealthCareEpisod” and “inform(HCE)” are stored in the HCP local agent database 33. The “inform(HCE)” object is then transmitted to the institutional collector agent 27, and stored in the institutional collector database 29. Once the patient file and the customized protocols are sent, the HCP agent needs to subscribe to the monitoring data that will eventually be received by the institutional collector agent 27, in response to the customized protocol.

In order to subscribe to the monitoring data, the HCP agent sends a “subscribe” message to the institutional collector agent 27. The latter sends to the management agent 21 a “ValidRights” message to verify whether the HCP agent has the rights to access the monitoring data it requested from the patient. Management agent 21 verifies the HCP agent's rights in the HCP access rights database 35, and informs the institutional collector agent 27 of the validity of the HCP agent's request. Depending on the determined validity of the request, the institutional collector agent 27 sends the HCP agent an “agree” or “refuse” message. In the case where an “agree” message is sent, a professional subscription generator comprised in the institutional collector agent 27, generates and stores a professional subscription corresponding to the professional subscription request sent by the HCP agent, on the hard disk of institutional collector agent 27.

The protocols can only get to the patient through the private network zone 19. Only two components are necessary to ensure the system's functionality in that particular zone: the public collector database 17, and the public collector agent 15. The public collector database 17 comprises for each institutional collector agent 27, an institutional access rights profile, used by the public collector agent 15 to ensure that the monitoring data of a specific patient are only distributed to institutions entitled to receive them. As for the public collector agent 15, it is a component by which monitoring data and treatment plans are adequately routed to their destination.

After storing the professional subscription, the institutional collector agent 27 transforms “inform(HCE)” into another Java object, “PatientEpisod”, which is adapted for execution on the patient apparatus 3, stored in the institutional collector database 29 and sent to the public collector agent 15. Afterwards, the institutional collector agent 27 sends a “subscribe” message to the public collector agent 15, in order to subscribe to the monitoring data that will eventually be received from the patient in response to the protocols it sent.

The public collector agent 15 checks the validity of the request according to the institutional access rights stored in the public collector database 17.

In a preferred embodiment, the public collector database 17 is maintained by a system administrator. The public collector agent 15 sends to the institutional collector agent 27 an “accept” or a “reject” message, according to the validity of the request. If the request is accepted, the public collector agent 15 stores an institutional subscription on its hard drive, corresponding to the institutional subscription request. If however, the request is rejected, the “reject” message is relayed by the institutional collector agent 27 to the HCP agent.

In a preferred embodiment, the patient agent authenticates the public collector agent 15, to prevent interceptions of monitoring data by unauthorized public collector agents.

The patient agent has the ability to receive protocols from different HCPs, and merge them into a single, efficient protocol. The merging is performed by a protocol driver that has the ability to concurrently execute a plurality of protocols. When the patient agent receives the protocols, the protocol driver requests from each protocol, their next scheduled activity, and stores them in its task manager according to their scheduled execution date.

Each protocol received by the patient agent has a scheduling routine that determines which protocol step has to be sent next, to the protocol driver's task manager. The scheduling routine determines the next protocol step using the protocol steps' scheduled execution time, and the most recent monitoring data. Each protocol step, on each protocol, is scheduled relatively to a certain event. For instance, the patient declares to his doctor that he has breakfast every morning at 7:00 AM, and protocol step 1 is scheduled 20 minutes after breakfast time. The protocol driver will access the most recent monitoring data sent by the patient, determine that the last occurrence of protocol step 1 was on August 20^{th}, at 7:20 AM, and calculate that the next scheduled execution is on August 21^{st}, at 7:20 AM.

Before displaying a protocol step, the protocol driver determines whether it has been recently completed, by going through the most recent monitoring data. If it has been completed indeed, the protocol driver sends the monitoring data corresponding to the protocol step to the public collector agent 15, which prevents patients from completing the same protocol step encountered in different protocols. Otherwise, the protocol driver displays the protocol step, requests another step from the protocol that sent the displayed protocol step, and stores the new step in its task manager according to its scheduled execution time. If the protocol step displayed is not completed on time, the protocol driver can either replace the step on top of the task manager's list, or further in the sequence. The process goes on until all scheduled protocol steps have been executed, or until the patient decides to end the protocol session. In the latter case, the patients next protocol session will display protocol steps he was scheduled to complete in previous sessions, before displaying the current session's scheduled protocol steps.

When conflicts are detected between protocols steps, the two protocols in conflict are sent back to the appropriate HCP with an explaining message for the conflict. The two HCP may then change the protocol to avoid future conflicts.

The patient clicks on a “send” icon after each completion of a protocol step, in order to have the next scheduled step displayed, and the monitoring data sent to the public collector 15, where it is received by a public collector attribute determinator. In one embodiment, the public collector attribute determinator determines attributes of the received monitoring data, compares the determined attributes to data attributes associated with health care institutions subscriptions, according to the institutional subscriptions, and sends to the institutional collector agent 27 every monitoring data it is entitled to receive.

In another embodiment, the public collector attribute determinator waits for the institutional collector agents 27 to send data requests before sending them the monitoring data they are entitled to receive according to the accepted subscription.

In one embodiment, the patient clicks on a “send” icon, after completing all the scheduled protocol steps, or when he decides to end the protocol session. Instead of receiving one monitoring data at a time, the public collector attribute determinator receives a set of monitoring data, and determines the attributes of each monitoring data unit comprised in the set.

Monitoring data sent by the public collector agent 15 to the institutional collector agent 27, are stored in the institutional collector database 29, and transmitted to an institutional collector attribute determinator. The institutional attribute determinator determines attributes of the monitoring data it received, compares the determined attributes to data attributes associated with HCPs according to professional subscriptions stored on the hard disk of the institutional collector and sends each HCP agent every monitoring data it is entitled to receive.

The level of importance that is attributed to the data of a patient, and which may be based on the patient's profile, may be used to display the data by the HCP agent. For instance, a level of blood glucose is critical for the monitoring of a diabetic and can have a high level of importance. Beyond a certain threshold, the data related to the blood glucose of the patient may be displayed using a particular color.

In one embodiment, the HCP agent can display the monitoring data on a first in, first out arrival basis. The HCP agent may also display the monitoring data with tables. The tables may be sorted by level of importance or by any other pre-defined criteria.

Although the system is described as allowing for remote health care monitoring, it can alternatively be applied in other environments such as personal finance. In one embodiment, if an accountant works for an institution, and wants to receive specific data from a specific client, he sends a subscription request to his institutional collector agent, which will store it in a institutional collector database and relay it to a public collector agent, which in turn will store it in a public collector database. The client, using a bootstrap, which he received from the institution or the system's administration, can download his personal agent, on his personal computer, and request to receive his accounting and investments data from the public collector agent. The client will receive, among other data, the accountant's subscription request, specifying the type of data the accountant would like to receive from him. The client can then accordingly send an “accept” or “reject” message to the public collector agent. If the client sends a “reject” message, the public collector agent erases the subscription request and sends the “reject” message to the institutional collector agent of the accountant's institution. Subsequently, the institutional collector agent erases the subscription request and relays the “reject” message to the accountant's agent. If, however, the public collector agent receives an “accept” message, it will generate and store an institutional subscription corresponding to the subscription request it had stored in the public collector database. The “accept” message will then be sent to the institutional collector agent corresponding to the accountant's institution, causing the it to generate and store an accountant subscription based on the subscription request it had stored in memory. Consequently, the accountant gets an “accept” message from the institutional collector agent, giving him the right to receive, from the client, data corresponding to the subscription. Information gathering data sent by various accountants and professionals are then merged, using a process similar to the one described above for protocol merging, to eliminate redundant data requests.

If the accountant is not part of an institution, he can communicate directly with the public collector agent, instead of going through an institutional collector agent.

In another embodiment, the institutional collector agents verifies the validity of subscription requests, according to a professional access rights database, describing the type of data that can be requested from a specific client, by a specific professional, or professional profile. If the subscription request is valid, it is sent to the public collector agent. The public collector agent then verifies the validity of the subscription request according to an institutional access rights database, describing the type of data that can be requested from a specific client by a specific institution. If the subscription request is valid, it is sent to the client's personal agent, for a last approval. If however, a subscription is determined to be invalid, at any level of the system, the professional agent receives a “reject” message. The extra step of checking in access rights databases can be very convenient for protecting a client's rights, and limits the number of irrelevant subscription requests received by clients.

Another example of the system's applications relates to polling. A client can send an “AgreeToPolling” message to a public collector agent, which will generate and store an institutional access right in a public collector database, allowing polling institutions to send subscription requests to the client. Once an access right is generated, the public collector agent sends polling institutions an “inform” message, kit signaling that a specific client has accepted to receive polling subscription requests. Polling institutions subsequently send polling subscription requests to the public collector agent, which verifies if the client specified in the requests has agreed to receive them, according to the institutional access rights stored in the public collector database. If the client has indeed agreed to receive polling subscription requests, the public collector agent sends them to the client's personal agent. The client then sends an “agree” or reject” message to the public collector agent, depending on whether he would like to fill out a polling form coming from that particular institution. If the public collector agent receives an “agree” message, it generates and stores an institutional subscription in memory, corresponding to the polling subscription request.

When polling forms are received by a personal agent, a polling driver requests a first question from the first polling form. In response to the request, the first polling form sends the polling driver the first question on its list using its question driver. When the question is answered, the protocol driver sends the answer to the first polling form and requests the next question. The polling form's question driver determines the next question, according to the given answer, and sends it to the protocol driver. The process is repeated until the first polling form is completed. For all subsequent protocols, the same process is used, but the protocol driver verifies if any of the client's previous answers, correspond to the next question to be asked, before displaying the next question. If an answer does indeed correspond to the next question to be asked, the form receives the answer and determines the next question to be asked accordingly. The merging process thus eliminates all redundancies that can be found in the received polling forms.

The invention can therefore be applied to a large variety of fields outside of the health care industry, and many applications will be apparent to a person skilled in the art. Therefore, the scope of the invention should not be determined by the examples described above, but by the appended claims and their legal equivalents.

1-12. (canceled)

13. A method for generating an clinical protocol for a patient suffering from an illness, the clinical protocol comprising a list of tasks to be performed by a patient, the method comprising the steps of:
selecting a generic clinical protocol in accordance with the illness of the patient, the selecting comprising the providing of an identifier identifying the illness, the selecting being generated by a medical professional;
providing the generic clinical protocol to the medical professional;
modifying the provided generic clinical protocol to adapt it to the patient, the modification being performed by the medical professional to create a clinical protocol, the modifying comprising the providing of at least one of the list of tasks to be performed in accordance with the illness of the patient;
transmitting the clinical protocol to the patient; and executing the transmitted clinical protocol.

14. The method as claimed in claim 13, further comprising the step of storing the transmitted clinical protocol to the patient in a database.

15. The method as claimed in claim 13, further comprising the step of sharing the provided clinical protocol with a medical professional.

16. The method as claimed in claim 13, further comprising the step of converting the format of the clinical protocol into an XML format.

17. The method as claimed in claim 13, wherein the step of transmitting the clinical protocol to the patient is performed through the Internet.

18. The method as claimed in claim 13, wherein the step of executing the transmitted clinical protocol comprises the step of downloading a bootstrap, the bootstrap enabling the patient to download and execute the transmitted clinical protocol.

19. The method as claimed in claim 13, wherein the step of selecting a generic clinical protocol in accordance with the illness of the patient, comprises the step of selecting a generic clinical protocol delivering authority, the selected generic clinical protocol delivering authority being checked in order to find if it is allowable.

20. The method as claimed in claim 13, wherein the step of executing the transmitted clinical protocol is performed according to a scheduled course of action set by the medical professional during the step of modifying the provided generic clinical protocol to adapt it to the patient.
